(19) United States
(12) Patent Application Publication
(10) Pub. No.: US 2025/0260311 A1
(43) Pub. Date: Aug. 14, 2025

(54) POWER SUPPLY CIRCUIT WITH SOFT START FOR POWER SUPPLY RAILS

(71) Applicant: QUALCOMM Incorporated, San Diego, CA (US)

(72) Inventors: Guoyong GUO, San Jose, CA (US); Qian YAO, Cupertino, CA (US); Jonathan LUTY, San Diego, CA (US); Xinying DING, Cupertino, CA (US); Daryl BERGSTROM, Chandler, AZ (US)

(21) Appl. No.: 18/442,011

(22) Filed: Feb. 14, 2024

(51) Int. Cl. H02M 1/36; H02J 7/00; H02M 3/07

(52) U.S. Cl. CPC H02M 1/36; H02J 7/007; H02M 3/07; H02J 2207/20

(57) ABSTRACT

Techniques and apparatus for soft starting power supply voltages in a power supply circuit for multiple batteries. One example power supply circuit generally includes a switching regulator including an output selectively coupled to at least one of a first power supply rail or a second power supply rail, a first battery node for coupling to a first battery, a second battery node for coupling to a second battery, a first set of transistors coupled between the first power supply rail and the first battery node, a second set of transistors coupled between the second power supply rail and the second battery node, a voltage regulator (VR), and a charge pump (CP) circuit. The CP circuit generally includes a first terminal coupled to the first power supply rail, a second terminal coupled to the second power supply rail, and a power supply input coupled to an output of the VR.

### TECHNICAL FIELD

Certain aspects of the present disclosure generally relate to power supply circuits and, more particularly, to techniques and apparatus for soft starting one or more power supply rails in a power supply circuit for multiple independent batteries.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

For example, a buck converter is a type of SMPS typically comprising: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches are typically implemented with transistors, although the low-side switch may alternatively be implemented with a diode.

A charge pump is a type of SMPS typically comprising at least one switching device to control the connection of a supply voltage across a load through a capacitor. In a voltage doubler (also referred to as a “multiply-by-two (X2) charge pump”), for example, the capacitor of the charge pump circuit may initially be connected across the supply, charging the capacitor to the supply voltage. The charge pump circuit may then be reconfigured to connect the capacitor in series with the supply and the load, doubling the voltage across the load. This two-stage cycle is repeated at the switching frequency for the charge pump. Charge pumps may be used to multiply or divide voltages by integer or fractional amounts, depending on the circuit topology.

Power management integrated circuits (power management ICs or PMICs) are used for managing the power scheme of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure provide a power supply circuit. The power supply circuit generally includes a switching regulator including an output selectively coupled to at least one of a first power supply rail or a second power supply rail, a first battery node for coupling to a first battery, a second battery node for coupling to a second battery, a first set of transistors coupled between the first power supply rail and the first battery node, a second set of transistors coupled between the second power supply rail and the second battery node, a voltage regulator, and a charge pump circuit. The charge pump circuit generally includes a first terminal coupled to the first power supply rail, a second terminal coupled to the second power supply rail, and a power supply input coupled to an output of the voltage regulator.

Certain aspects of the present disclosure are directed to a method of supplying power. The method generally includes generating, via a voltage regulator, a power supply voltage from an input voltage node coupled to an input of a switching regulator or from a battery node for coupling to a battery, the switching regulator including an output selectively coupled to at least one of a first power supply rail or a second power supply rail and the second power supply rail being coupled to the battery node via a set of transistors; powering a charge pump circuit with the power supply voltage, the charge pump circuit comprising a first terminal coupled to the first power supply rail and a second terminal coupled to the second power supply rail; and soft starting at least one of a voltage of the first power supply rail or a voltage of the second power supply rail after powering the charge pump circuit.

Certain aspects of the present disclosure provide an integrated circuit (e.g., a power management integrated circuit (PMIC)) comprising at least a portion of any of the power supply circuits described herein.

Certain aspects of the present disclosure provide a battery charging circuit comprising any of the power supply circuits described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device comprising a power management system that includes a power management integrated circuit (PMIC) and a battery charging circuit, in which aspects of the present disclosure may be practiced.

FIG. 2 is a circuit diagram of an example power supply circuit, in accordance with certain aspects of the present disclosure.

FIG. 3A is a circuit diagram of an example power supply circuit that includes a charge pump circuit coupled between battery nodes, in accordance with certain aspects of the present disclosure.

FIG. 3B is a circuit diagram of an example power supply circuit that includes a charge pump circuit coupled between power supply rails and includes switches between battery nodes and the power supply rails, in accordance with certain aspects of the present disclosure.

FIGS. 3C and 3D are circuit diagrams of example power supply circuits that may include multiple charge pump circuits, in accordance with certain aspects of the present disclosure.

FIG. 4 is a block diagram of an example soft start interface that may be included in the power supply circuits of FIGS. 3B-3D, in accordance with certain aspects of the present disclosure.

FIGS. 5A-E illustrate operation of parts of the example power supply circuit of FIG. 3B that includes the soft start interface of FIG. 4 in different scenarios, in accordance with certain aspects of the present disclosure.

FIG. 6 is a flow diagram of example operations for supplying power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for soft starting one or more power supply rails in a power supply circuit for multiple independent batteries. Such a power supply circuit may include a charge pump (CP) circuit coupled between multiple power supply rails and a voltage regulator (VR) configured to supply the CP circuit with power during soft start. The CP circuit may be configured to receive an enable signal for controlling the timing of CP circuit operations. For certain aspects, the power supply circuit may include a temperature sensor and/or current sinks coupled to the power supply rails.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

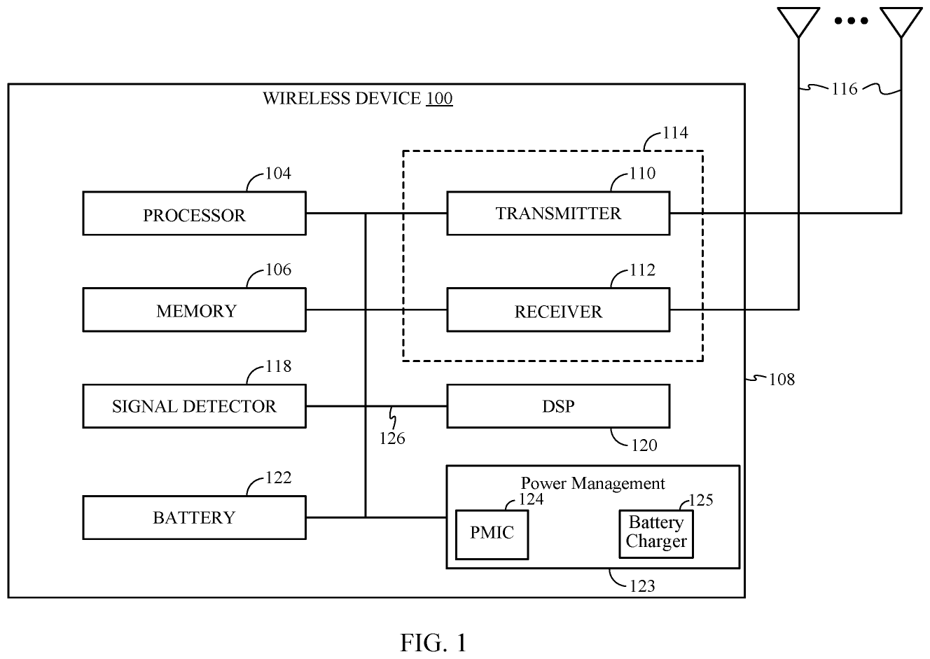

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, an augmented reality device, etc. For certain aspects, the device 100 may be a foldable device (e.g., a flip phone).

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a transmitter 110 and/or a receiver 112 to allow transmission and/or reception, respectively, of data between the device 100 and a remote location. For certain aspects, the transmitter 110 and receiver 112 may be combined into a transceiver 114. One or more antennas 116 may be attached or otherwise coupled to a housing 108 of the device 100 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source-such as a wall adapter or a wireless power charger—is unavailable). The battery 122 may comprise a single cell or multiple cells connected in series and/or in parallel. The device 100 may further include additional independent batteries (not shown). Each of the additional independent batteries may comprise a single cell or multiple cells connected in series and/or in parallel.

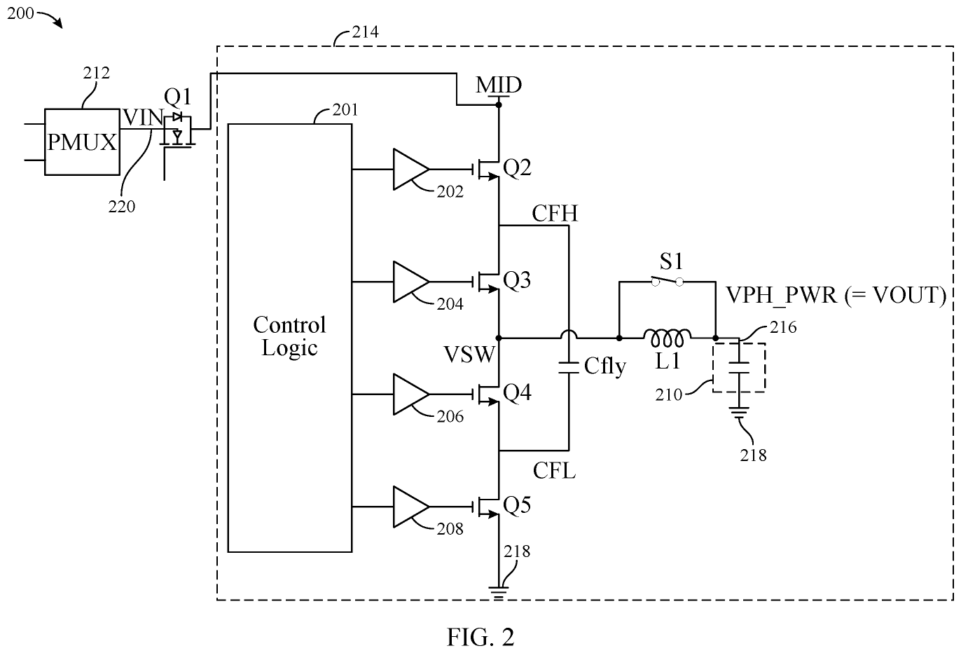

The device 100 may also include a power management system 123 for managing the power from the battery 122 (or batteries), a wall adapter, and/or a wireless power charger to the various components of the device 100. The power management system 123 may perform a variety of functions for the device such as DC-to-DC conversion, battery charging, power-source selection, voltage scaling, power sequencing, source mode power, etc. In certain aspects, the power management system 123 may include a power management integrated circuit (power management IC or PMIC) 124 and one or more power supply circuits, such as a battery charger 125, which may be controlled by the PMIC or logic associated with the battery charger, for example. For certain aspects, at least a portion of one or more of the power supply circuits (e.g., at least a portion of the battery charger 125) may be integrated in the PMIC 124. The PMIC 124 and/or the one or more power supply circuits may include at least a portion of a switched-mode power supply (SMPS) circuit, which may be implemented by any of various suitable switched-mode power supply circuit topologies, such as a two-level buck converter, a three-level buck converter, a CP, or an adaptive combination power supply circuit (e.g., the SMPS circuit 214 of FIG. 2), which can switch between operating in a buck converter mode and a CP mode, as described below.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Power Supply Circuits and Operation

As described above, the PMIC 124 and/or the one or more power supply circuits (e.g., battery charger 125) may include at least a portion of an SMPS circuit (e.g., a buck converter, a CP converter, or an adaptive combination power supply circuit capable of switching therebetween), which may be a single-phase or multi-phase converter. In the case of an adaptive combination power supply circuit, both converter modes may be single-phase, both converter modes may be multi-phase, one converter mode may be single-phase while the other converter mode is multi-phase or capable of changing between single-phase and multi-phase, or one converter mode may be multi-phase while the other converter mode is capable of changing between single-phase and multi-phase.

FIG. 2 is a circuit diagram of an example power supply circuit 200, which may be used to charge one or more batteries and/or provide power to one or more power supply rails. As illustrated, the power supply circuit 200 includes a power multiplexer 212 (labeled “PMUX”), a reverse-current-blocking transistor Q1 (which may also be referred to as an overvoltage protection (OVP) field-effect transistor (FET) or an input FET), and an SMPS circuit 214 (e.g., an adaptive SMPS circuit).

The power multiplexer 212 may be configured to select between receiving power from, for example, (i) a Universal Serial Bus (USB) port for connecting to a wall adapter and (ii) a wireless power port (both not shown). The power multiplexer 212 may be implemented as a single-pole, double-throw (SPDT) switch by two OVP FETs, and in this case, transistor Q1 may be eliminated.

In certain aspects, the output of the power multiplexer 212 may be coupled to an input voltage node 220 (labeled “VIN”). The input voltage node 220 may be coupled to a source of the transistor Q1, and a drain of the transistor Q1 may be coupled to a voltage node (labeled “MID”) of the SMPS circuit 214. The MID voltage node may serve as the power supply rail of the SMPS circuit 214, and in some cases, may alternatively be considered as an input node of the SMPS circuit 214. In some cases, the power multiplexer 212 and/or transistor Q1 may be removed.

For certain aspects, the SMPS circuit 214 may have a two-level buck converter topology. For other aspects, the SMPS circuit 214 may have a single-phase three-level buck converter topology (as illustrated in the power supply circuit 200 of FIG. 2), and may include a second transistor Q2, a third transistor Q3, a fourth transistor Q4, a fifth transistor Q5, a flying capacitive element Cfly, an inductive element L1, and a load 210, which is represented here by a capacitor. For other aspects, the SMPS circuit 214 may have a dual-phase three-level buck converter topology. To realize an adaptive SMPS circuit, a switch Si may be added across the inductive element L1 of the three-level buck converter topology. With the switch Si closed, the adaptive SMPS circuit may function as a single-phase divide-by-two (Div2) CP converter, as further described below. In certain aspects, switch Si may be implemented by two back-to-back transistors.

Transistor Q3 may be coupled to transistor Q2 via a first node (labeled “CFH” for flying capacitor high node), transistor Q4 may be coupled to transistor Q3 via a second node (labeled “VSW” for voltage switching node), and transistor Q5 may be coupled to transistor Q4 via a third node (labeled “CFL” for flying capacitor low node). For certain aspects, the transistors Q2-Q5 may be implemented as n-type metal-oxide-semiconductor (NMOS) transistors, as illustrated in FIG. 2. In this case, the drain of transistor Q3 may be coupled to the source of transistor Q2, the drain of transistor Q4 may be coupled to the source of transistor Q3, and the drain of transistor Q5 may be coupled to the source of transistor Q4. The source of transistor Q5 may be coupled to a reference potential node 218 (e.g., electric ground) for the power supply circuit 200. The flying capacitive element Cfly may have a first terminal coupled to the first node and a second terminal coupled to the third node. The inductive element L1 may have a first terminal coupled to the second node and a second terminal coupled to an output voltage node 216 (labeled “VOUT,” which may also be referred to as “VPH_PWR” or “VPH”) and the load 210.

Control logic 201 may control operation of the SMPS circuit 214 and other aspects of the power supply circuit 200. For example, the control logic 201 may control operation of the transistors Q2-Q5 via output signals to the inputs of respective gate drivers 202, 204, 206, and 208. The outputs of the gate drivers 202, 204, 206, and 208 are coupled to respective gates of transistors Q2-Q5. During operation of the adaptive SMPS circuit (or of a three-level buck converter), the control logic 201 may cycle through four different phases, which may differ depending on whether the duty cycle is less than 50% or greater than 50%.

Operation of the adaptive SMPS circuit with a duty cycle of less than 50% is described first. In a first phase (referred to as a “charging phase”), transistors Q2 and Q4 are activated, and transistors Q3 and Q5 are deactivated, to charge the flying capacitive element Cfly and to energize the inductive element L1. In a second phase (called a “holding phase”), transistor Q2 is deactivated, and transistor Q5 is activated, such that the VSW node is coupled to the reference potential node, the flying capacitive element Cfly is disconnected (e.g., one of the Cfly terminals is floating), and the inductive element L1 is deenergized. In a third phase (referred to as a “discharging phase”), transistors Q3 and Q5 are activated, and transistor Q4 is deactivated, to discharge the flying capacitive element Cfly and to energize the inductive element L1. In a fourth phase (also referred to as a “holding phase”), transistor Q4 is activated, and transistor Q3 is deactivated, such that the flying capacitive element Cfly is disconnected and the inductive element L1 is deenergized.

Operation of the adaptive SMPS circuit with a duty cycle greater than 50% is similar in the first and third phases, with the same transistor configurations. However, in the second phase (called a “holding phase”) following the first phase, transistor Q4 is deactivated, and transistor Q3 is activated, such that the VSW node is coupled to the MID node, the flying capacitive element Cfly is disconnected, and the inductive element L1 is energized. Similarly in the fourth phase (also referred to as a “holding phase”) with a duty cycle greater than 50%, transistor Q2 is activated, and transistor Q5 is deactivated, such that the flying capacitive element Cfly is disconnected and the inductive element L1 is energized.

Furthermore, the control logic 201 may have a control signal (not shown in FIG. 2) configured to control operation of switch Si and selectively enable divide-by-two (Div2) CP operation. For certain aspects, when this control signal is logic low, switch Si is open, and the power supply circuit 200 operates as a three-level buck converter using the inductive element L1. When this control signal is logic high for certain aspects, switch Si is closed, thereby shorting across the inductive element L1 and effectively removing the inductive element L1 from the circuit, such that the adaptive SMPS circuit operates as a Div2 CP. The control logic 201 may be configured to automatically control operation of switch Si (e.g., through the logic level of the control signal) based on an output current (also referred to as a “load current”) and/or an input current for the adaptive SMPS circuit.

### Example Power Supply Circuits with Charge Pump Circuit

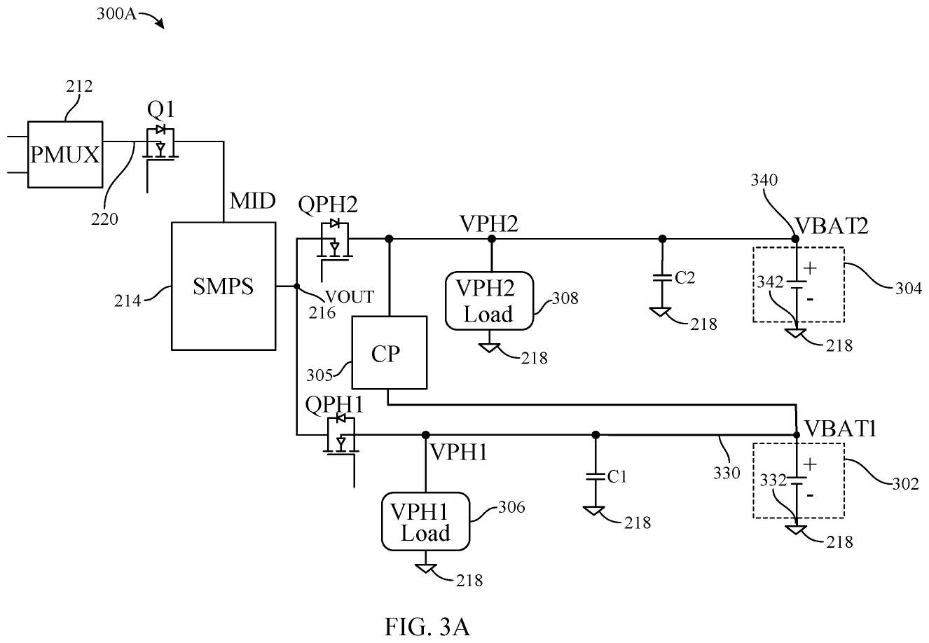

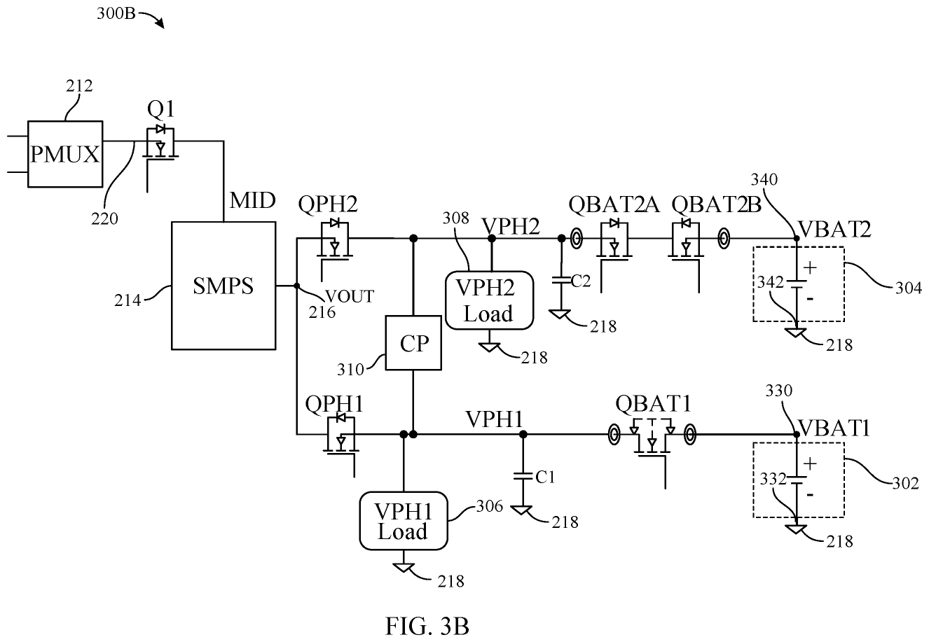

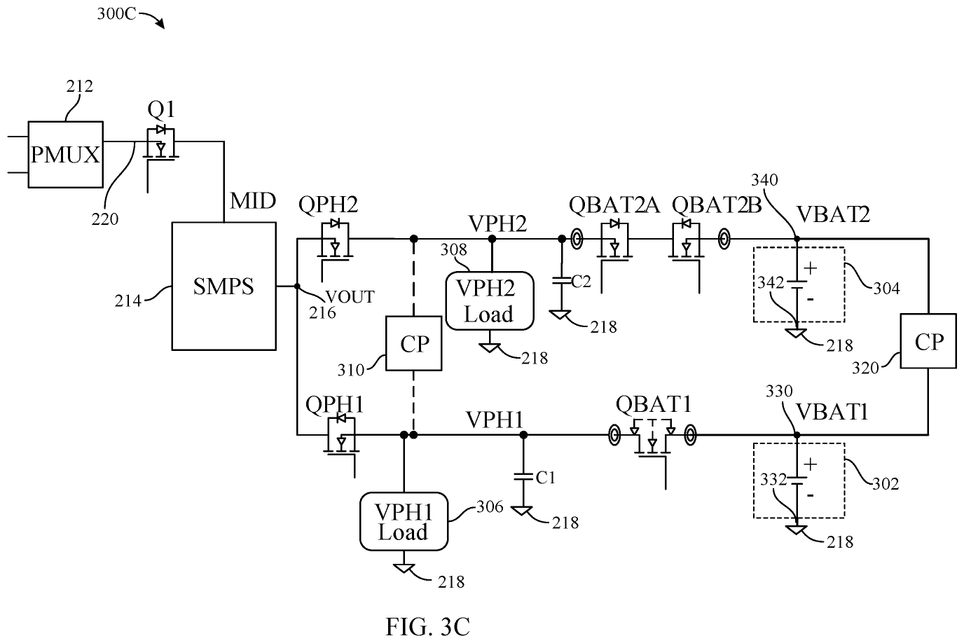

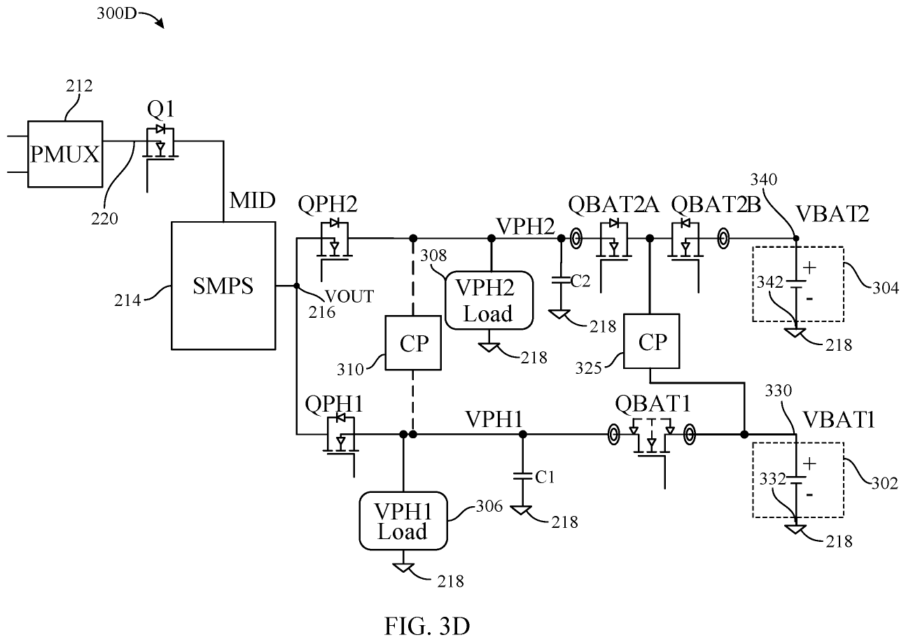

FIG. 3A is a circuit diagram of an example power supply circuit 300A, in accordance with certain aspects of the present disclosure. The power supply circuit 300A includes the power multiplexer 212, the transistor Q1, a switching regulator (e.g., the SMPS circuit 214 or another suitable SMPS circuit), a battery node 330 for coupling to a battery 302, a battery node 340 for coupling to a battery 304, and a CP circuit 305 coupled between the battery nodes 330, 340. The batteries 302, 304 may be external to an integrated circuit (IC) (e.g., a PMIC), whereas at least a portion of the SMPS circuit 214 may be internal to the IC. Battery 302 may be a single-cell battery, whereas battery 304 may be a multi-cell-in-series battery, such as a two-cell-in-series (2S) battery (with two stacked cells in a single battery). In other words, battery 302 and battery 304 may be asymmetrical batteries, each with a different capacity (and size). In this case, a first power supply rail VPH1 coupled to the battery node 330 may have a lower voltage than a second power supply rail VPH2 coupled to the battery node 340. The CP circuit 305 may be used in a first direction (e.g., from the power supply rail VPH1 to the power supply rail VPH2) to generate a higher voltage from a lower voltage and in a second direction (e.g., from the power supply rail VPH2 to the power supply rail VPH1) to generate a lower voltage from a higher voltage. The power supply circuit 300A may also include a capacitive element C1 (e.g., a bypass capacitor) coupled between the power supply rail VPH1 and the reference potential node 218 and a capacitive element C2 (e.g., a bypass capacitor) coupled between the power supply rail VPH2 and the reference potential node 218, as shown.

The power supply circuit 300A may further include a load 306 (e.g., labeled “VPH1 Load”), another load 308 (e.g., labeled “VPH2 Load”), a first switch (e.g., implemented by one or more transistors QPH1), and a second switch (e.g., implemented by one or more transistors QPH2). The load 306 may represent one or more circuits of a device (e.g., the device 100 of FIG. 1) that are powered internally by the power supply rail VPH1. The power supply rail VPH1 may be provided power from the SMPS circuit 214 (e.g., when a power source external to the device is provided to the power multiplexer 212), from the battery 302 of the device (e.g., when no external power source is available), or from the CP circuit 305 from power supply rail VPH2. The load 308 may represent one or more circuits of a device (e.g., the device 100 of FIG. 1) that are powered internally by the power supply rail VPH2. The power supply rail VPH2 may be provided power from the SMPS circuit 214 (e.g., when a power source external to the device is provided to the power multiplexer 212), from the battery 304, or from the CP circuit 305 from power supply rail VPH1. The loads 306, 308 may each be coupled (in shunt) to the reference potential node 218. In some aspects, the load 308 may represent one or more circuits that include a display (e.g., AMOLED display), haptics boost, speaker amplifiers, and/or any other load that may use a relatively high voltage domain.

The power supply circuit 300A may be included in a device that is foldable, which may include a first portion coupled to a second portion by a hinge. In this example, the first portion of the foldable device may include the battery 302, and the second portion of the foldable device may include the battery 304. In certain aspects, the battery 302 may be the same battery type as the battery 304.

In the power supply circuit 300A, the output voltage node 216 of the SMPS circuit 214 may be selectively coupled to the load 306 and the load 308 via transistor(s) QPH1 and transistor(s) QPH2, respectively. In certain aspects, transistor(s) QPH1 and/or QPH2 may be implemented by back-to-back transistors or a body-switchable transistor, for example. The gates of transistors QPH1 and QPH2 may be driven by logic circuitry (e.g., the control logic 201 of FIG. 2 or other logic not shown in FIG. 3A). Transistor(s) QPH1 may be coupled to the battery 302 via the power supply rail VPH1 coupled to the battery node 330 (labeled “VBAT1”), and transistor(s) QPH2 may be coupled to the battery 304 via the power supply rail VPH2 coupled to the battery node 340 (labeled “VBAT2”).

The CP circuit 305 may have a first terminal coupled to the battery node 330 (providing the CP circuit 305 access to power through the battery 302) and a second terminal coupled to the battery node 340 (providing the CP circuit 305 access to power through the battery 304). The CP circuit 305 may be implemented as an X2 CP, a multiply-by-four (X4) CP, a Div2 CP, a divide-by-four (Div4) CP, or a CP with any other suitable voltage conversion. In a first direction, the CP circuit 305 may be configured to generate the power supply rail VPH2 from the power supply rail VPH1 (e.g., to charge the battery 304 and/or provide power to the load 308). In a second direction, the CP circuit 305 may be configured to generate the power supply rail VPH1 from the power supply rail VPH2 (e.g., to charge the battery 302 and/or provide power to the load 306). For example, the CP circuit 305 may multiply voltage in the first direction (e.g., operate as an X2, X4, or other CP) and may divide voltage in the second direction (e.g., operate as a Div2, Div4, or other CP), or vice versa for power supply circuits with other battery configurations. In some aspects, the power supply rail VPH2 has a higher voltage than the power supply rail VPH1. For example, the CP circuit 305 may double the voltage at the power supply rail VPH1 to generate the power supply rail VPH2, to enable the power supply circuit 300A to supply both a power supply rail in a relatively low voltage domain (e.g., associated with the power supply rail VPH1) and a power supply rail in a relatively high voltage domain (e.g., associated with the power supply rail VPH2).

When the batteries 302, 304 are external to an IC with other circuitry of the power supply circuit 300A, the IC may include a positive battery port (e.g., a pin) coupled to the battery node 330 and to the positive terminal of the battery 302. In some cases, the IC may include a negative battery port coupled to the battery node 332 and to the negative terminal of the battery 302. Additionally or alternatively, the IC may include a positive battery port coupled to the battery node 340 and to the positive terminal of the battery 304. In some cases, the IC may include a negative battery port coupled to the battery node 342 and to the negative terminal of the battery 304. The battery node 332 and the battery node 342 may each be coupled to the reference potential node 218.

According to certain aspects, a CP circuit included in a power supply circuit may not have direct access to power through either the switching regulator or any of the batteries. FIG. 3B is a circuit diagram of an example power supply circuit 300B with a different topology where the CP circuit is without direct access to power, in accordance with certain aspects of the present disclosure. The power supply circuit 300B of FIG. 3B may be similar to the power supply circuit 300A of FIG. 3A, but with a charge pump circuit 310 coupled in a different manner within the power supply circuit 300B. For example, in the power supply circuit 300B, a first terminal of the CP circuit 310 (and the power supply rail VPH1) is separated from the battery node 330 by a third switch (e.g., implemented by one or more transistor(s) QBAT1), and a second terminal of the CP circuit 310 (and the power supply rail VPH2) is separated from the battery node 340 by a fourth switch (e.g., implemented by one or more transistors QBAT2, shown implemented in FIG. 3B as transistors QBAT2A, QBAT2B). The charge pump circuit 310 of FIG. 3B may be similar to the charge pump circuit 305 of FIG. 3A, other than being connected in a different manner within the power supply circuit.

In certain aspects, only one of the batteries 302, 304 may be present in the power supply circuit 300B. For example, battery 304 may be present and coupled to the battery node 340, whereas battery node 330 may be coupled to the reference potential node 218 (without being coupled to a battery).

In certain aspects, the third and fourth switches may be bidirectional switches implemented with one or more transistors. In some cases, transistor(s) QBAT1 may be implemented by back-to-back transistors or a body-switchable transistor, for example. Transistor(s) QBAT2 may be implemented as back-to-back transistors, as shown, but may alternatively be implemented as a body-switchable transistor. The gates of transistors QBAT1 and QBAT2 may be driven by logic circuitry (e.g., the control logic 201 of FIG. 2 or other logic not shown in FIG. 3A). Transistor(s) QBAT1 may be coupled to the battery 302 via the battery node 330, and transistor(s) QBAT2 may be coupled to the battery 304 via the battery node 340, as illustrated.

FIGS. 3C and 3D are circuit diagrams of example power supply circuits 300C, 300D with alternate topologies that may include multiple charge pump circuits, in accordance with certain aspects of the present disclosure. The power supply circuit 300C of FIG. 3C may be similar to the power supply circuit 300B of FIG. 3B, but may additionally or alternatively include a CP circuit 320 coupled between the battery node 330 and the battery node 340. In other words, in certain aspects, the power supply circuit 300C may lack the CP circuit 310. The CP circuit 320 may be similar to the CP circuit 310. As such, the CP circuit 320 may be implemented as an X2 CP, an X4 CP, a Div2 CP, a Div4 CP, or a CP with any other suitable voltage conversion.

The power supply circuit 300D of FIG. 3D may be similar to the power supply circuit 300B of FIG. 3B, but may additionally or alternatively include a CP circuit 325 coupled between the battery node 330 and transistor(s) QBAT2. In other words, in certain aspects, the power supply circuit 300D may lack the CP circuit 310. In certain aspects, transistor(s) QBAT2 may be implemented as back-to-back transistors QBAT2A and QBAT2B, as shown, and the CP circuit 325 may be coupled between the battery node 330 and the drains of transistors QBAT2A and QBAT2B, as shown. The CP circuit 325 may be implemented as an X2 CP, an X4 CP, a Div2 CP, a Div4 CP, or a CP with any other suitable voltage conversion.

### Example Soft Start Interface for Power Supply Circuits

In power supply circuits, the term “soft start” generally refers to an initial bring-up of a voltage in a slow and controlled manner, for example, to avoid an initial in-rush current to the bypass capacitors (e.g., capacitive elements C1, C2) when turning on a device, switching power sources, etc. As used herein, and with respect to the power supply rails VPH1 and VPH2, a soft start may refer to a phase during which one or more associated transistors (e.g., transistor(s) QBAT1 for the battery 302 and/or transistor(s) QBAT2 for the battery 304) are biased in a linear region of operation before the transistors are fully turned on (e.g., biased in saturation). Soft start may be performed to charge a capacitive element (e.g., the capacitive elements C1, C2 on the power supply rails VPH1, VPH2) to a voltage that is within a certain threshold of the battery voltage before the associated transistor(s) for the battery are fully turned on, as described in more detail herein.

Many portable devices (e.g., foldable and flip phones and Internet of things (IoT) devices) may utilize power supply circuits with multiple independent batteries and a CP circuit, such as the power supply circuits 300A, 300B of FIGS. 3A and 3B, respectively. However, the CP circuit may not have direct access to power through either a switching regulator or any of the batteries of the power supply circuit, which introduces challenges in providing soft start and other protective capabilities in the power supply circuit. It is desirable to enable the power supply circuits to provide comprehensive soft start capabilities and thermal management, as well as deal with residual voltage or a low voltage emulated battery plug-in.

Certain aspects of the present disclosure provide techniques and apparatus for providing comprehensive soft start and other protective capabilities using a power supply circuit with a CP circuit and a soft start interface between the CP circuit and other portions of the power supply circuit (hereinafter referred to as the “main charger”). For example, the main charger may include a switching regulator (e.g., the SMPS circuit 214), the transistor(s) QPH1, QPH2, QBAT1, and QBAT2, and control logic (e.g., the control logic 201). In certain aspects, the main charger (e.g., with the control logic) may manage the startup sequence of the power supply circuit. A voltage regulator (VR) may be added to the main charger and may be configured to supply power to the CP circuit. The soft start interface may enable a soft start of voltages at the power supply rails of a power supply circuit with multiple batteries (both with battery-only provided power and with externally provided power, such as from wall adapter or wireless charger), including in cases where the power supply circuit includes one or more supercapacitors (e.g., coupled to the power supply rails or replacing one or more of the batteries and having a capacitance of 5 mF or greater). For thermal management and handling residual power supply rail voltages before and/or during soft start, the main charger may also include a temperature sensor (e.g., for sensing a die temperature of the relevant portion of the power supply circuit) and/or current sinks coupled to one or more of the power supply rails. For certain aspects, the power supply circuit may also be capable of supporting potential low voltage emulated battery plug-ins.

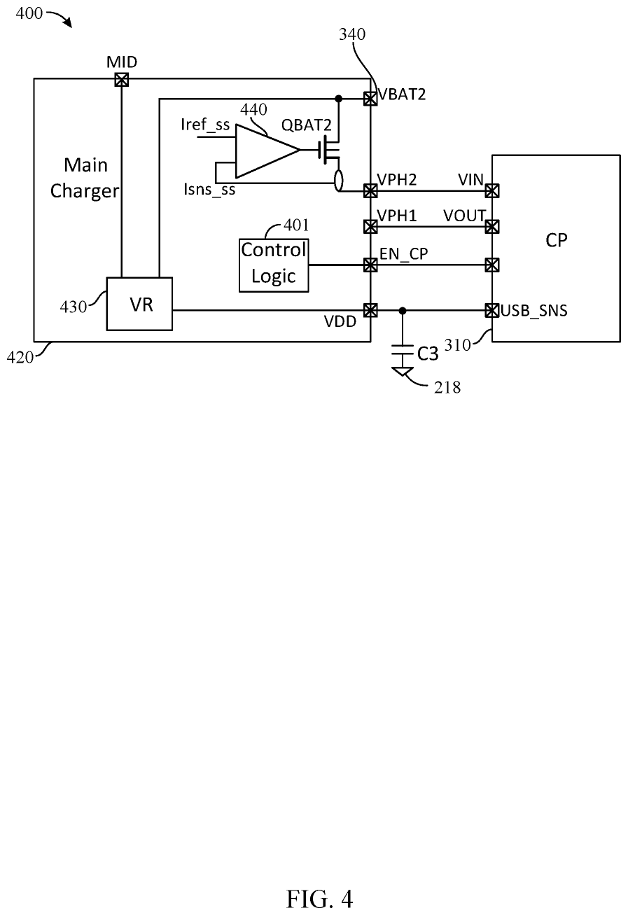

FIG. 4 is a block diagram of an example soft start interface 400, in accordance with certain aspects of the present disclosure. The soft start interface 400 may be included in the power supply circuits 300B, 300C, 300D of FIGS. 3B-3D, for example. The soft start interface 400 may include the CP circuit 310 and a main charger 420 (e.g., that may include or be part of the battery charger 125). The main charger 420 may include transistor(s) QBAT2, control logic 401 (e.g., which may be or at least include part of the control logic 201 of FIG. 2), a VR 430 (which may be implemented by a low-dropout (LDO) regulator, such as a 5 V LDO regulator), and an amplifier 440. For certain aspects, the main charger 420 may also include the SMPS circuit 214 (not shown in FIG. 4). In certain aspects, the CP circuit 310 may be implemented on a different IC than the main charger 420, and the connections between the CP circuit 310 and the main charger 420 may pass through ports on the CP circuit 310 and the main charger 420, as shown. In other aspects, the CP circuit 310 may be implemented on the same IC as the main charger 420.

When the CP circuit 310 is external to the main charger 420, the CP circuit 310 may include a power supply input (labeled “USB_SNS”) coupled to an output node of the VR 430 (labeled “VDD”) through a port (e.g., a pin or solder ball), a first terminal referred to as an output (labeled “VOUT”) coupled to the power supply rail VPH1 (labeled “VPH1”) through a port, and a second terminal referred to as an input (labeled “VIN”) coupled to the power supply rail VPH2 (labeled “VPH2”) through a port. The output node VDD of the VR 430 may be coupled to a capacitive element C3 (e.g., bypass capacitor) that is coupled (in shunt) to the reference potential node 218.

The VR 430 may include a first input coupled to the MID voltage node of the SMPS circuit 214 (labeled “MID”) through a port and a second input coupled to the battery node 340 (labeled “VBAT2”) through a port. In this manner, the VR 430 may be configured to provide power (e.g., through the output VDD node) to the CP circuit 310 from an external power source (e.g., a wall adapter or wireless charger, through the SMPS circuit 214) or the battery 304. The control logic 401 may include a control output (labeled “EN_CP”) coupled to an enable input of the CP circuit 310 through a port, as shown. The control logic 401 may also be used to control the selection between the inputs to the VR 430. In some cases, the control logic 401 may further include additional control outputs (not shown) coupled to control inputs of the SMPS circuit 214 (e.g., similar to the gate drive signals of the control logic 201 of FIG. 2).

### Example Soft Start Scenarios

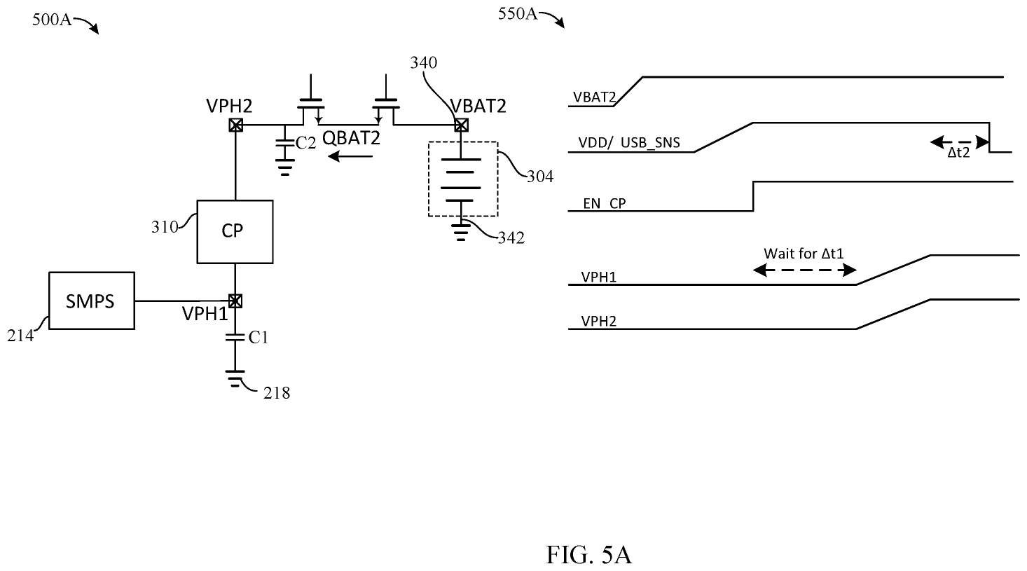

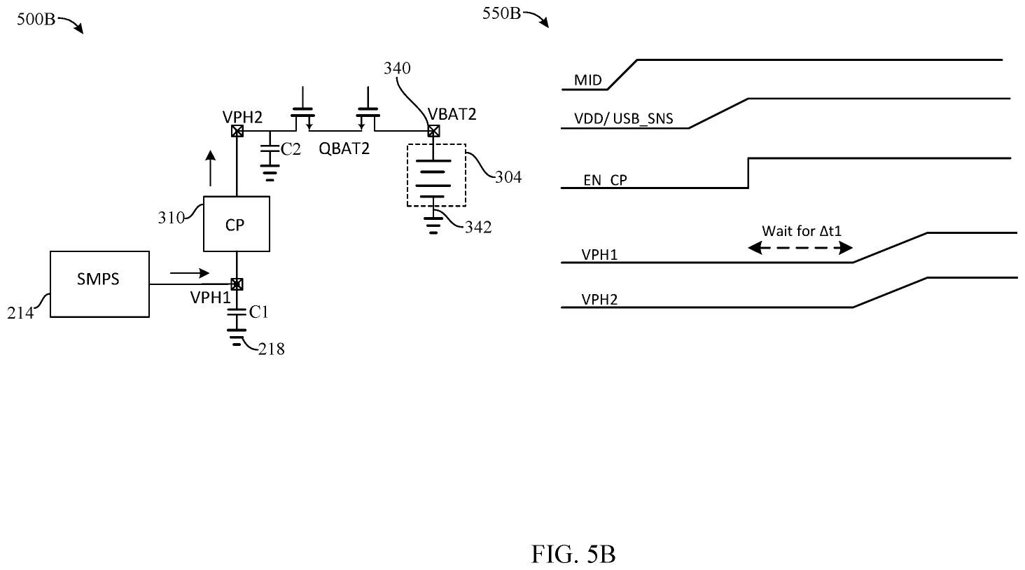

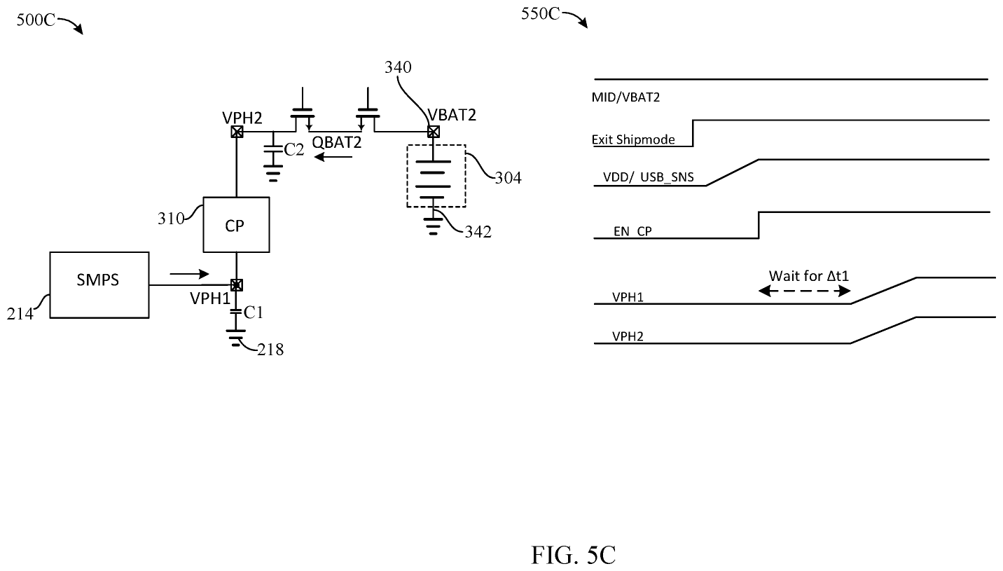

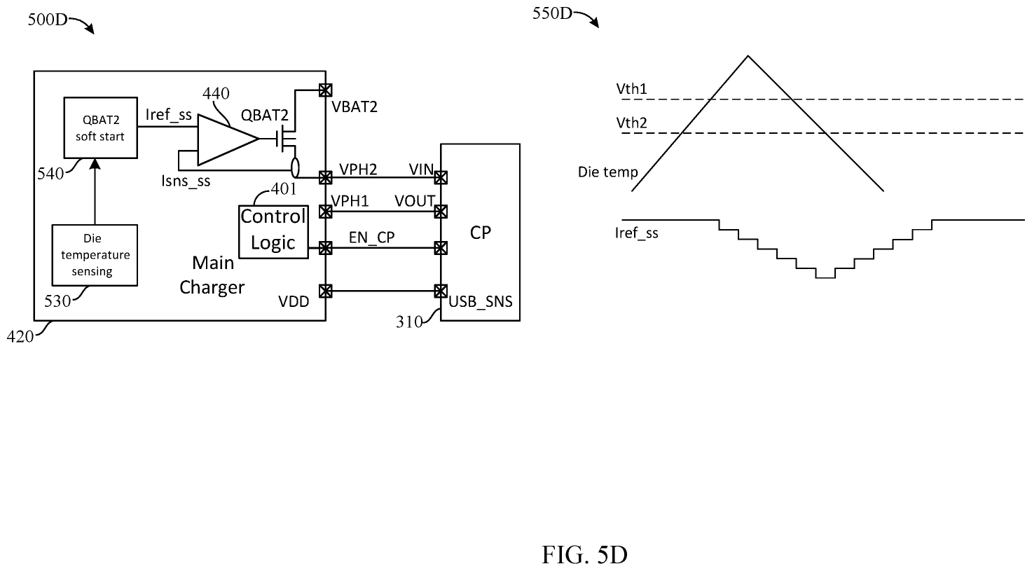

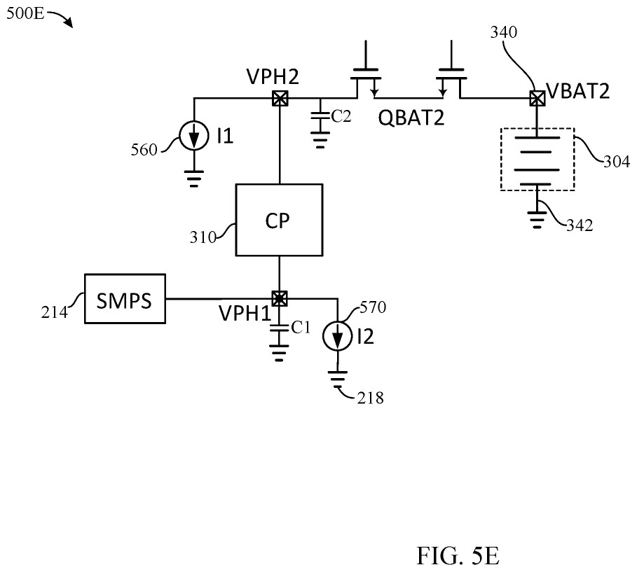

FIGS. 5A-C illustrate operation of portions 500A, 500B, 500C of the example power supply circuit 300B of FIG. 3B that includes the soft start interface 400 of FIG. 4 in different scenarios, in accordance with certain aspects of the present disclosure.

In some scenarios, the power supply circuit 300B may provide power solely from the battery 304 (e.g., no external power source is available). When the battery 304 is plugged in (or the device is turned on), the power supply circuit 300B may perform a soft start using transistor(s) QBAT2 to charge the power supply rail VPH2 and the CP circuit 310 to charge the power supply rail VPH1 from the power supply rail VPH2. In these scenarios, and as shown in the portion 500A of the power supply circuit 300B and in the timing diagram 550A, when the battery 304 is provided to the battery node 340 and the second input of the VR 430, the voltage at the battery node 340 (labeled “VBAT2”) begins to rise. The control logic 401 may control the VR 430 to select the second input of the VR 430, and then, because there is now power at the battery node 340, the output voltage (labeled “VDD/USB_SNS” in the timing diagram 550A) from the VR 430 begins to rise, supplying power to the CP circuit 310 (e.g., through the USB_SNS port shown in FIG. 4). Sometime later (e.g., after the VR output voltage VDD/USB_SNS has settled or is sufficiently high), the enable signal (labeled “EN_CP”) on the control output may be changed by the control logic 401 from logic low to logic high, thereby enabling the CP circuit 310 to operate (e.g., in a Div2 mode or other division mode). In certain aspects, the control logic 401 may be configured to delay outputting the enable signal to enable the CP circuit 310 until the power supply rail VPH1 is discharged below a first threshold voltage and/or the power supply rail VPH2 is discharged below a second threshold voltage.

During the soft start and after the control logic 401 outputs the enable signal, the control logic 401 may be configured to delay for a time interval Δt1 (e.g., about 50 milliseconds (ms)) before weakly turning on transistor(s) QBAT2 to gradually charge the power supply rail VPH2 and provide a voltage input for the CP circuit 310 to gradually charge the power supply rail VPH1, as shown. This delay for time interval Δt1 may be used in an effort to ensure the CP circuit 310 is ready to operate after being enabled. In certain aspects, the control logic 401 included in the soft start interface 400 may be configured to receive an indication of a current sensed through transistor(s) QBAT2 and to control a slew rate of the soft start of the power supply rail VPH1 and the power supply rail VPH2 based on the sensed current.

In certain aspects, the control logic 401 may be configured to turn off the output power VDD/USB_SNS after completion of the soft start of the voltages on the power supply rail VPH1 and the power supply rail VPH2 after a delay Δt2 (e.g., 20 ms), as shown. In this manner, the operating current of the power supply circuit 300B may be lowered.

In some scenarios, the battery 304 may be dead, significantly drained, or missing. In order to provide power to the power supply rails VPH1 and VPH2 (and in some cases, to charge the battery 304), an external power source (e.g., a wall adapter or a wireless power charger) may be plugged into the device with the power supply circuit 300B. In these scenarios, when the external power source is plugged in, transistor(s) QBAT2 may be turned off, the SMPS circuit 214 may be initially turned off, and the power supply circuit 300B may perform a soft start of the power supply rail VPH1 and the power supply rail VPH2 using the SMPS circuit 214 to charge the power supply rail VPH1 and the CP circuit 310 to charge the power supply rail VPH2 from the power supply rail VPH1. As shown in the portion 500B of the power supply circuit 300B and the timing diagram 550B, when the external power source is provided (e.g., to transistor Q1), a voltage at the MID node (labeled “MID”) begins to rise and is provided to an input of the SMPS circuit 214 and the first input of the VR 430. The control logic 401 may select the first input of the VR 430, and then, because there is now power at the MID node, the output voltage (labeled “VDD/USB_SNS” in the timing diagram 550B) from the VR 430 begins to rise, supplying power to the CP circuit 310 (e.g., through the USB_SNS port shown in FIG. 4). Sometime later (e.g., after the VR output voltage VDD/USB_SNS has settled or is sufficiently high), the enable signal (labeled “EN_CP”) on the control output may be changed by the control logic 401 from logic low to logic high, thereby enabling the CP circuit 310 to operate (e.g., in an X2 mode or other multiplying mode). In this manner, the CP circuit 310 is provided power by the VR 430 and is enabled.

During the soft start and after the control logic 401 outputs the enable signal, the control logic 401 may be configured to delay for a time interval Δt1 (e.g., about 50 ms) before controlling the SMPS circuit 214 to operate (e.g., in a buck converter mode with an increasing output voltage) to gradually charge the power supply rail VPH1 and provide a voltage input for the CP circuit 310 to gradually charge the power supply rail VPH2. This delay for time interval Δt1 may be used in an effort to ensure the CP circuit 310 is ready to operate after being enabled. The power supply circuit 300B may continue to output power to the CP circuit 310 after the completion of the soft start of the power supply rail VPH1 and the power supply rail VPH2.

In some cases, a device (that includes the power supply circuit 300B) may be placed in ship mode or automatic fault protection (AFP) mode (e.g., when a short circuit has occurred on one or more of the power supply rails). In ship mode or AFP mode, the SMPS circuit 214 and transistors QBAT1 and QBAT2 may be turned off. Upon exiting ship or AFP mode, the power supply circuit 300B may perform a soft start using the SMPS circuit 214 and transistor(s) QBAT2 to charge (e.g., parallel charge) the power supply rail VPH1 and the power supply rail VPH2. As shown in the portion 500C of the power supply circuit 300B and the timing diagram 550C, when exiting ship mode or AFP mode (as illustrated by the transition in the signal labeled “Exit Shipmode”), a voltage at the MID node and a battery voltage at the battery 304 may both be already on and available, as indicated by the voltage signal labeled “MID/VBAT2.” Because these voltages are already available, the control logic 401 may select one of the inputs to the VR 430, and the output voltage (labeled “VDD/USB_SNS”) begins to rise, supplying power to the CP circuit 310 (e.g., through the USB_SNS port shown in FIG. 4). As described above, the enable signal (labeled “EN_CP”) on the control output may be changed by the control logic 401 from logic low to logic high, thereby enabling the CP circuit 310 to operate. In cases where both MID and BAT2 voltages are available, the CP circuit may operate in a multiplication mode (e.g., an X2 mode) or a division mode (e.g., a Div2 mode). The mode of operation for the CP circuit 310 may depend on which path dominates after the CP circuit 310 is powered on by the VR 430 and enabled.

During the soft start and after the control logic 401 outputs the enable signal, the control logic 401 may be configured to delay for a time interval Δt1 (e.g., about 50 ms) before controlling the SMPS circuit 214 to operate and weakly turning on transistor(s) QBAT2 to gradually charge the power supply rail VPH1 and the power supply rail VPH2. The power supply circuit 300B may continue to output power to the CP circuit 310 after the completion of the soft start of the power supply rail VPH1 and the power supply rail VPH2. In this manner, furthermore, the soft start time for a supercapacitor on either of the power supply rails VPH1 and VPH2 when exiting from ship or AFP mode may be reduced compared to some conventional techniques for soft starting with a supercapacitor.

FIG. 5D illustrates thermal management operations of a portion 500D of the example power supply circuit 300B of FIG. 3B, in accordance with certain aspects of the present disclosure. In this case, the main charger 420 may further include die temperature sensing circuitry 530 and QBAT2 soft start circuitry 540 to provide thermal management during soft start. For certain aspects, the QBAT2 soft start circuitry 540 may be part of the control logic 401.

In operation, the main charger 420 may sense a current through transistor(s) QBAT2 during soft start and provide an indication of the sensed current (labeled “Isns_ss”) to an input of the amplifier 440. Based on a difference between the indication of the sensed current Isns_ss and an indication of a reference current (labeled “Iref_ss”), the amplifier 440 is configured to drive the gate(s) of transistor(s) QBAT2 to control the on-resistance (and hence, the current flow) through transistor(s) QBAT2. The indication of the reference current Iref_ss is programmed and provided by the QBAT2 soft start circuitry 540.

In some aspects, the die temperature sensing circuitry 530 may sense a temperature associated with a die (labeled “Die temp” in timing diagram 550D) that includes the SMPS circuit 214, the control logic 401, and transistor(s) QBAT2. The die temperature may be provided to and used by the QBAT2 soft start circuitry 540 to program the indication of the reference current Iref_ss. After entering soft start, the die temperature may likely increase, as current flows through transistor(s) QBAT2 and other components, heating up the die. When the die temperature reaches a first threshold temperature (e.g., labeled “Vth1”) during soft start, Iref_ss may be decreased, thereby decreasing the gate voltage(s) for transistor(s) QBAT2 to decrease the current flow through transistor(s) QBAT2 in an effort to lower the die temperature. In certain aspects, Iref_ss may be decreased decrementally by the QBAT2 soft start circuitry 540. When the die temperature falls below a second threshold temperature (e.g., labeled “Vth2”), Iref_ss may be increased, thereby increasing the gate voltage(s) for transistor(s) QBAT2 to increase the current flow through transistor(s) QBAT2 and allow the die temperature to increase, as shown in the timing diagram 550D. In some aspects, one or more of Vth1, Vth2, the adjustment step for Iref_ss, and the slew rate (e.g., how quickly Iref_ss is adjusted) may be programmable. For certain aspects, the incremental adjustment step (and/or incremental slew rate) may be different than the decremental adjustment step (and/or decremental slew rate).

The CP circuit 310 may not function as intended for soft start when residual voltage is present on the power supply rail VPH1 and/or the power supply rail VPH2 during an initial soft start. Certain aspects of the present disclosure are directed towards techniques for managing residual voltage on the power supply rail(s).

In certain aspects, before soft starting the power supply rails, the main charger 420 may detect voltage at the power supply rail VPH1 and the power supply rail VPH2, and if either of the voltages at VPH1 or VPH2 is higher than some threshold (e.g., 0.7 V), the main charger 420 may effectively enable a pulldown current source (a current sink) coupled to a respective battery node (e.g., battery node 330 or battery node 340) to remove, or at least decrease below a suitable level, any residual charge. For example, referring to FIG. 5E, which illustrates an example portion 500E of the power supply circuit of FIG. 3B in this scenario, current sinks 560, 570 (e.g., pulldown current sources, labeled “I1” and “I2” respectively) may be selectively coupled (e.g., by a switch (not shown)) to the power supply rail VPH2 and the power supply rail VPH1, respectively. For example, the current sinks 560, 570 may be 10 mA current sinks. One or more of the current sinks 560, 570 may be effectively selectively enabled (e.g., by closing a switch (not shown) in series with the current sink) by the control logic 401 for discharging the respective power supply rail(s) with residual voltage before soft start. For example, the control logic 401 may be configured to effectively enable the current sink 570 when a residual voltage of the power supply rail VPH1 is higher than a first threshold voltage before the soft start. Similarly, the control logic 401 may be configured to effectively enable the current sink 560 when a residual voltage of the power supply rail VPH2 is higher than a second threshold voltage before the soft start. A current may be sunk via the associated current sink from the power supply rail VPH1, VPH2 for a certain period (e.g., 1 ms). After the period, the current sink may be effectively disabled (e.g., by opening the switch in series), and the power supply rail VPH1, VPH2 may be sensed and compared to a threshold voltage to determine whether the residual voltage has been sufficiently reduced. The main charger 420 may delay the enabling of the CP circuit 310 (e.g., using the En_CP signal) until both the power supply rails VPH1, VPH2 have been sufficiently discharged.

For certain aspects, the power supply circuits described herein may also be capable of supporting potential low voltage emulated battery plug-ins. In certain aspects, an analog-to-digital (ADC) (not shown) may be configured to measure a voltage of a battery node 330 or 340, when a battery is connected to the power supply circuit (and when a wall adapter, a wireless power charger, or other external power source is unavailable). When this plug-in voltage is less than a threshold voltage (e.g., 5 V), the control logic 401 may cause the power supply circuit to enter an automatic fault protection (AFP) mode, to protect various components from a short circuit. For example, during the AFP mode, the transistor(s) QBAT2 may be turned off.

Although the examples above focus on power supply circuits with two power supply rails, it is to be understood that the aspects described herein for providing comprehensive soft start may be used in power supply circuits with any number of power supply rails, and for batteries with any number of cells.

### Example Soft Start Operations

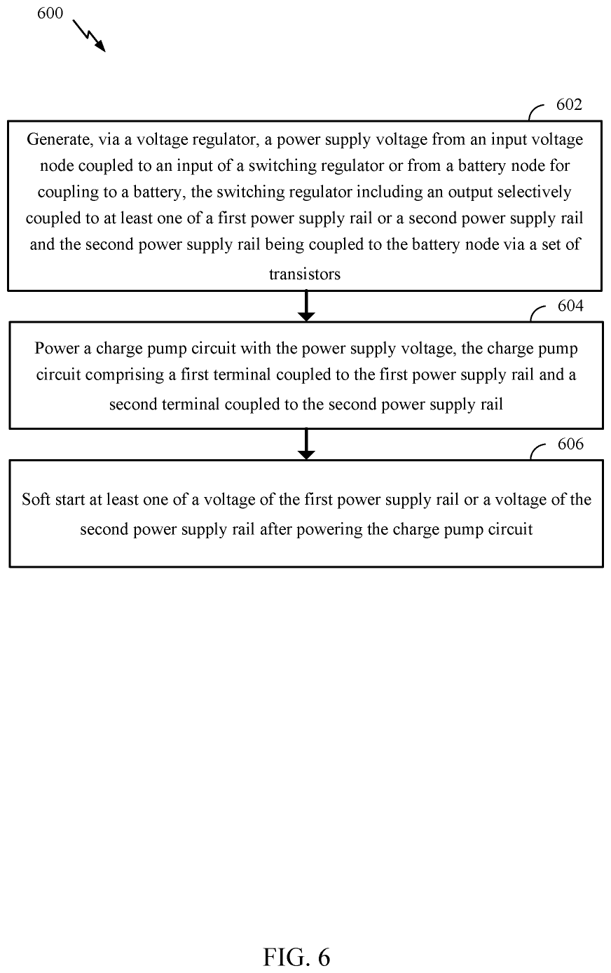

FIG. 6 is a flow diagram of example operations 600 for supplying power, in accordance with certain aspects of the present disclosure. The operations 600 may be performed by a power supply circuit (e.g., the power supply circuits, 300B, 300C, 300D of FIGS. 3B-3D) that includes a soft start interface (e.g., the soft start interface 400 of FIG. 4 or FIG. 5D).

The operations 600 may include, at block 602 generating, via a VR (e.g., VR 430), a power supply voltage (e.g., VDD/USB_SNS) from an input voltage node (e.g., MID voltage node) coupled to an input of a switching regulator (e.g., SMPS circuit 214) or from a battery node (e.g., battery node 340) for coupling to a battery (e.g., battery 304). The switching regulator may include an output (e.g., output voltage node 216) selectively coupled (e.g., via transistor QPH1 or QPH2) to at least one of a first power supply rail (e.g., power supply rail VPH1) or a second power supply rail (e.g., power supply rail VPH2). The second power supply rail may be coupled to the battery node via a set of transistors (e.g., one or more transistors QBAT2).

At block 604, the operations 600 may include powering a CP circuit (e.g., CP circuit 310) with the power supply voltage. The CP circuit may include a first terminal (e.g., VOUT terminal) coupled to the first power supply rail and a second terminal (e.g., VIN terminal) coupled to the second power supply rail.

At block 606, the operations 600 may include soft starting at least one of a voltage of the first power supply rail or a voltage of the second power supply rail after powering the CP circuit.

According to certain aspects, the operations 600 may further include enabling the CP circuit before the soft starting at block 606 and after powering the CP circuit at block 604. In these aspects, after the enabling, the operations 600 may further include delaying for a time interval (e.g., time interval Δt1) before charging at least one of the first power supply rail or the second power supply rail during the soft starting. In certain aspects, before the enabling, the operations 600 may further include delaying enabling the CP circuit until the first power supply rail is discharged below a first threshold voltage and the second power supply rail is discharged below a second threshold voltage (e.g., as described with respect to FIG. 5E).

According to certain aspects, the operations 600 may further include sensing a current (Isns_ss) through the set of transistors or through another set of transistors (e.g., one or more transistors QBAT1) coupled between the first power supply rail and another battery (e.g., battery 302) and controlling a slew rate of the soft starting of the at least one of the voltage of the first power supply rail or the voltage of the second power supply rail, based on the sensed current.

According to certain aspects, the operations 600 may further include: (i) sensing a temperature associated with a die (e.g., Die temp) including the switching regulator, (ii) decreasing a reference current (Iref_ss) for the soft starting if the temperature exceeds a first threshold temperature (e.g., Vth1), and (iii) increasing the reference current for the soft starting if the temperature falls below a second threshold temperature (e.g., Vth2).

According to certain aspects, the operations 600 may further include effectively enabling a first current sink (e.g., current sink 560) coupled to the first power supply rail when a residual voltage of the first power supply rail is higher than a first threshold voltage before the soft starting. Additionally or alternatively, the operations 600 may further include effectively enabling a second current sink (e.g., current sink 570) coupled to the second power supply rail when a residual voltage of the second power supply rail is higher than a second threshold voltage before the soft start.

### Example Aspects

In addition to the various aspects described above, specific combinations of aspects are within the scope of the disclosure, some of which are detailed below:

Aspect 1: A power supply circuit comprising: a switching regulator including an output selectively coupled to at least one of a first power supply rail or a second power supply rail; a first battery node for coupling to a first battery; a second battery node for coupling to a second battery; a first set of transistors coupled between the first power supply rail and the first battery node; a second set of transistors coupled between the second power supply rail and the second battery node; a voltage regulator; and a charge pump circuit comprising: a first terminal coupled to the first power supply rail; a second terminal coupled to the second power supply rail; and a power supply input coupled to an output of the voltage regulator.

Aspect 2: The power supply circuit of Aspect 1, wherein the voltage regulator includes a first input coupled to an input of the switching regulator and a second input coupled to the second battery node.

Aspect 3: The power supply circuit of Aspect 1 or 2, further comprising control logic including a control output coupled to an enable input of the charge pump circuit.

Aspect 4: The power supply circuit of Aspect 3, wherein during a soft start of the first power supply rail and the second power supply rail, the control logic is configured to output an enable signal on the control output to enable the charge pump circuit after the charge pump circuit is powered on by the voltage regulator.

Aspect 5: The power supply circuit of Aspect 4, wherein during the soft start and after the control logic outputs the enable signal, the control logic is configured to delay for a time interval before controlling at least one of the switching regulator, the first set of transistors, or the second set of transistors to charge the first power supply rail and the second power supply rail.

Aspect 6: The power supply circuit of Aspect 4 or 5, wherein the control logic is further configured to delay outputting the enable signal to enable the charge pump circuit until the first power supply rail is discharged below a first threshold voltage and the second power supply rail is discharged below a second threshold voltage.

Aspect 7: The power supply circuit according to any of Aspects 4-6, wherein the control logic is further configured to sense a current through the first set of transistors or the second set of transistors and control a slew rate of the soft start of the first power supply rail and the second power supply rail based on the sensed current.

Aspect 8: The power supply circuit according to any of Aspects 4-7, wherein the control logic is further configured to: receive an indication of a temperature associated with a die including the switching regulator and the control logic; decrease a reference current for the soft start of the first power supply rail and the second power supply rail if the temperature exceeds a first threshold temperature; and increase the reference current for the soft start of the first power supply rail and the second power supply rail if the temperature falls below a second threshold temperature.

Aspect 9: The power supply circuit according to any of Aspects 3-8, further comprising: a first current sink coupled to the first power supply rail; and a second current sink coupled to the second power supply rail, wherein the control logic is configured to effectively selectively enable the first current sink and the second current sink.

Aspect 10: The power supply circuit of Aspect 9, wherein the control logic is further configured to: enable the first current sink when a residual voltage of the first power supply rail is higher than a first threshold voltage before the soft start; and enable the second current sink when a residual voltage of the second power supply rail is higher than a second threshold voltage before the soft start.

Aspect 11: The power supply circuit according to any of Aspects 3-10, wherein the control logic further includes additional control outputs coupled to control inputs of the switching regulator.

Aspect 12: An integrated circuit (IC) comprising the power supply circuit according to any of Aspects 1-11.

Aspect 13: A method of supplying power, the method comprising: generating, via a voltage regulator, a power supply voltage from an input voltage node coupled to an input of a switching regulator or from a battery node for coupling to a battery, the switching regulator including an output selectively coupled to at least one of a first power supply rail or a second power supply rail and the second power supply rail being coupled to the battery node via a set of transistors; powering a charge pump circuit with the power supply voltage, the charge pump circuit comprising a first terminal coupled to the first power supply rail and a second terminal coupled to the second power supply rail; and soft starting at least one of a voltage of the first power supply rail or a voltage of the second power supply rail after powering the charge pump circuit.

Aspect 14: The method of Aspect 13, further comprising enabling the charge pump circuit before the soft starting and after powering the charge pump circuit.

Aspect 15: The method of Aspect 14, further comprising, after the enabling, delaying for a time interval before charging at least one of the first power supply rail or the second power supply rail during the soft starting.

Aspect 16: The method of Aspect 14 or 15, further comprising, before the enabling, delaying enabling the charge pump circuit until the first power supply rail is discharged below a first threshold voltage and the second power supply rail is discharged below a second threshold voltage.

Aspect 17: The method according to any of Aspects 13-16, further comprising: sensing a current through the set of transistors or through another set of transistors coupled between the first power supply rail and another battery; and controlling a slew rate of the soft starting of the at least one of the voltage of the first power supply rail or the voltage of the second power supply rail, based on the sensed current.

Aspect 18: The method according to any of Aspects 13-17, further comprising: sensing a temperature associated with a die including the switching regulator; decreasing a reference current for the soft starting if the temperature exceeds a first threshold temperature; and increasing the reference current for the soft starting if the temperature falls below a second threshold temperature.

Aspect 19: The method according to any of Aspects 13-18, further comprising enabling a first current sink coupled to the first power supply rail when a residual voltage of the first power supply rail is higher than a first threshold voltage before the soft starting.

Aspect 20: The method of Aspect 19, further comprising enabling a second current sink coupled to the second power supply rail when a residual voltage of the second power supply rail is higher than a second threshold voltage before the soft start.

### ADDITIONAL CONSIDERATIONS

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of. a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a switching regulator including an output selectively coupled to at least one of a first power supply rail or a second power supply rail;
a first battery node for coupling to a first battery;
a second battery node for coupling to a second battery;
a first set of transistors coupled between the first power supply rail and the first battery node;
a second set of transistors coupled between the second power supply rail and the second battery node;
a voltage regulator; and
a charge pump circuit comprising:
a first terminal coupled to the first power supply rail;
a second terminal coupled to the second power supply rail; and
a power supply input coupled to an output of the voltage regulator.

2. The power supply circuit of claim 1, wherein the voltage regulator includes a first input coupled to an input of the switching regulator and a second input coupled to the second battery node.

3. The power supply circuit of claim 1, further comprising control logic including a control output coupled to an enable input of the charge pump circuit.

4. The power supply circuit of claim 3, wherein during a soft start of the first power supply rail and the second power supply rail, the control logic is configured to output an enable signal on the control output to enable the charge pump circuit after the charge pump circuit is powered on by the voltage regulator.

5. The power supply circuit of claim 4, wherein during the soft start and after the control logic outputs the enable signal, the control logic is configured to delay for a time interval before controlling at least one of the switching regulator, the first set of transistors, or the second set of transistors to charge the first power supply rail and the second power supply rail.

6. The power supply circuit of claim 4, wherein the control logic is further configured to delay outputting the enable signal to enable the charge pump circuit until the first power supply rail is discharged below a first threshold voltage and the second power supply rail is discharged below a second threshold voltage.

7. The power supply circuit of claim 4, wherein the control logic is further configured to sense a current through the first set of transistors or the second set of transistors and control a slew rate of the soft start of the first power supply rail and the second power supply rail based on the sensed current.

8. The power supply circuit of claim 4, wherein the control logic is further configured to:
receive an indication of a temperature associated with a die including the switching regulator and the control logic;
decrease a reference current for the soft start of the first power supply rail and the second power supply rail if the temperature exceeds a first threshold temperature; and
increase the reference current for the soft start of the first power supply rail and the second power supply rail if the temperature falls below a second threshold temperature.

9. The power supply circuit of claim 4, further comprising:
a first current sink coupled to the first power supply rail; and
a second current sink coupled to the second power supply rail, wherein the control logic is configured to effectively selectively enable the first current sink and the second current sink.

10. The power supply circuit of claim 9, wherein the control logic is further configured to:
enable the first current sink when a residual voltage of the first power supply rail is higher than a first threshold voltage before the soft start; and
enable the second current sink when a residual voltage of the second power supply rail is higher than a second threshold voltage before the soft start.

11. The power supply circuit of claim 3, wherein the control logic further includes additional control outputs coupled to control inputs of the switching regulator.

12. An integrated circuit (IC) comprising the power supply circuit of claim 1.

13. A method of supplying power, the method comprising:
generating, via a voltage regulator, a power supply voltage from an input voltage node coupled to an input of a switching regulator or from a battery node for coupling to a battery, the switching regulator including an output selectively coupled to at least one of a first power supply rail or a second power supply rail and the second power supply rail being coupled to the battery node via a set of transistors;
powering a charge pump circuit with the power supply voltage, the charge pump circuit comprising a first terminal coupled to the first power supply rail and a second terminal coupled to the second power supply rail; and
soft starting at least one of a voltage of the first power supply rail or a voltage of the second power supply rail after powering the charge pump circuit.

14. The method of claim 13, further comprising enabling the charge pump circuit before the soft starting and after powering the charge pump circuit.

15. The method of claim 14, further comprising, after the enabling, delaying for a time interval before charging at least one of the first power supply rail or the second power supply rail during the soft starting.

16. The method of claim 14, further comprising, before the enabling, delaying enabling the charge pump circuit until the first power supply rail is discharged below a first threshold voltage and the second power supply rail is discharged below a second threshold voltage.

17. The method of claim 13, further comprising:
sensing a current through the set of transistors or through another set of transistors coupled between the first power supply rail and another battery; and
controlling a slew rate of the soft starting of the at least one of the voltage of the first power supply rail or the voltage of the second power supply rail, based on the sensed current.

18. The method of claim 13, further comprising:
sensing a temperature associated with a die including the switching regulator;
decreasing a reference current for the soft starting if the temperature exceeds a first threshold temperature; and
increasing the reference current for the soft starting if the temperature falls below a second threshold temperature.

19. The method of claim 13, further comprising enabling a first current sink coupled to the first power supply rail when a residual voltage of the first power supply rail is higher than a first threshold voltage before the soft starting.

20. The method of claim 19, further comprising enabling a second current sink coupled to the second power supply rail when a residual voltage of the second power supply rail is higher than a second threshold voltage before the soft start.
